(19) United States
(12) Patent Application Publication
(10) Pub. No.: US 2012/0290165 A1
(43) Pub. Date: Nov. 15, 2012

(54) Flexible Robotic Mower

(76) Inventor: Chien Ouyang, Pleasanton, CA (US)

(21) Appl. No.: 13/467,014

(22) Filed: May 8, 2012

Related U.S. Application Data
(60) Provisional application No. 61/518,595, filed on May 9, 2011.

(51) Int. Cl. G05D 1/02

(52) U.S. Cl. 701/25

(57) ABSTRACT

The flexible robotic lawn mower utilizes the ultrasonic sensor nodes installing on the border, inside the lawn yard, and outside the lawn yard, to define the lawn yard region, to detect the position of the robotic lawn mower base, and to program the mowing route and grass cutting depth. The system allows the users to freely vary the mowing regions and locations, and therefore provide the maximum flexibility.

### BACKGROUND OF THE INVENTION

1. Field of the Invention

The present invention relates generally to a flexible robotic lawn mower system. The users can use the system at different lawns and at different regions with a setup of sensor nodes to mow yard smartly. The sensor nodes here refer to ultrasonic sensors, but the light and RF sensors may be coupled to enhance the system. The sensors nodes may be built in on the stands and the stands may be installed near the yard border, inside, or outside of the lawn yard region. The patented system is to define the mowing region, to track the position of the mower during its operation at any time, and to mow the lawn region with a programmed route and pattern.

2. Description of the Related Art

With the invention of the robotic mower, people now can use it to do the lawn work and therefore save the time and energy for other things. A robotic law mower is an autonomous robot used to cut lawn grass. A typical robotic lawn mower requires the users to set up a wire at the lawn border to define the area to be mowed. The robot uses the wire to locate the boundary of the area to be trimmed, and in some applications, the robot can follow the wire back to the docking station for battery recharging. Robotic lawn mowers can be quite sophisticated equipped with sensors to detect if there is a rain and to detect grass and non-grass area and some models can control the blade speed based on grass height and move in spiral pattern when longer grass is found.

However, the existing lawn mowers in the market, although with microcontroller or a CPU embedded on them, are still not flexible enough to allow users to freely use it at different lawns, and to vary the mowing regions. For example, users may want to mow his or her house's lawn yard today, but tomorrow would like to help mow neighbor's lawn yard. The setup of the wire at neighbor's yard, if not impossible, would be very impractical. If the user is a gardener, he or she will definitely need to mow different lawn yards which have different landscapes and are at different locations, and the wirings will become extremely difficult and time consuming. Another application is that users may want to mow a specific region of lawn today and to mow another specific region of the lawn tomorrow. For this need, a flexible robotic lawn mower system which is able to define and to vary the mowing region and to track the location of the mower during its operation is needed. The invention here is to address these kinds of needs.

In this application, a flexible robotic mower, which allows users to freely use it for different lawns and at different regions in the lawn, is proposed. The invention is to install the ultrasonic transmitter and receivers near the peripheral of the lawn region. These ultrasonic transmitters and receivers for example are to be built in on the stands and the stands are to be installed on the grounds such as at the border of the lawn yard. Ideally the stands shall be flexible to be set up, and they shall be able to be put on or removed easily, and the stands may be flexibly moved and relocated to any different lawns or to different regions in the lawn. The robotic mower has ultrasonic receiver on it to receive the ultrasonic signals from the transmitter on the stands. From the received signals, the flexible robotic mower system will firstly define the region to be mowed based on a simulation algorithm. After that, the system will track the position of the robotic mower during its mowing operation at any time. By knowing of the robotic mower's position at any time during its operation, a mowing route and pattern may be programmed and executed to mow a specified region.

### SUMMARY OF THE INVENTION

The embodiment of the present invention provides a flexible robotic mowing system allowing users to use it at different lawns and at various regions in a lawn with a simple setup of the sensor nodes.

In one embodiment, the flexible robotic mowing system contains a robotic mower base, and several ultrasonic transmitters and receivers.

In one embodiment, the ultrasonic transmitter and receivers may be put on the stands and the stands are to set up on the ground near the border of the mowing region.

In one embodiment, the stands may be set up inside a mowing region and not exactly at the border of the lawn region, and may be set up outside the mowing region.

In one embodiment, the robotic lawn mower may have an ultrasonic receiver on it to receive and to detect the ultrasonic waves from the stands.

In one embodiment, the ultrasonic sensor nodes may be operated with different sound frequencies to avoid interference and to identity the locations of sensor nodes.

In one embodiment, the robotic mower may have an ultrasonic wave transmitter on it to detect the objects.

In one embodiment, the ultrasonic transmitters on the stands are to transmit ultrasonic waves toward the robotic mower and toward other stands.

In one embodiment, a CPU or a microcontroller may be on the robotic mower base or on the stands to do the calculation and simulation. The calculation is to determine the mowing region, to track the position of the mower at any time during its mowing operation, and to determine the mowing route and pattern, the mowing speed, mowing frequency, mowing depth, and mowing period.

In one embodiment, the mowing route and pattern may be programmed according to users' needs.

In one embodiment, the flexible robotic mower system may contain more than one robotic mower.

In one embodiment, the flexible robotic mower may have a temperature sensor on it to measure the temperature of the environment.

In one embodiment, the robotic mower may have a memory device on it for the storage means, and a map of mowing region may be stored in the memory device.

In one embodiment, a simulation algorithm may be used to determine the outer boundary of the mowing region based on the positions of the stands. The algorithm may be based on the positions of all stands or by the positions of a few stands.

In one embodiment, several nearby stands may form a local group, and a mathematic algorithm may be used to calculate how the stands are connecting with each other together, and therefore, the local border of the mowing region is defined.

In one embodiment, the stands and mower may be located on a flat or non-flat lawn and the system can be operated in a 2D domain when the lawn is flat, or in 3D domain when the lawn yard is not flat.

In one embodiment, the stands may extrude out of the ground plane and the configuration of the system is operated in 3D domain.

In one embodiment, the stands used to track the position of the mower may be located inside or outside the lawn to be mowed.

In one embodiment, a stands may be repeatedly used to define the border of the mowing region. The stand may be used, be removed, and be relocated to different locations. Once a position is defined, its coordinate is stored on a memory device which is on the robotic lawn mower base or on a stand. The positions of the stands may be used to build a map of the mowing region.

In one embodiment, the mowing route, directions, and patterns may be determined by the CPU or microcontroller in the mower, and the route, directions, and patterns may be based on the positions of the stands and mower.

In one embodiment, the grass cutting depth may be programmed by the users if an engraving of the yard is designed.

### BRIEF DESCRIPTION OF THE DRAWINGS

A better understanding of the present invention may be obtained when the following detailed description is considered in conjunction with the following drawings, in which:

FIG. 1 illustrates a flexible robotic mower base inside a lawn region.

FIG. 2 illustrates a flexible robotic mower base is located in a lawn and the lawn have several non-grass areas.

FIG. 3 illustrates several lawns are separated by the non-grass areas.

FIG. 4 illustrates a lawn is divided into several regions.

FIG. 5 illustrates a flexible robotic mower base is inside a mowing region and several stands are put into the ground at the border of the mowing region.

FIG. 6 illustrates a flexible robotic mower base is to receive ultrasonic waves from the stands, and one or more of stands may have ultrasonic wave receivers to receive ultrasonic wave signals from other stands.

FIG. 7 illustrates a flexible robotic mower is to receive the ultrasonic waves from the stands and the stands are to send and receive ultrasonic wave signals.

FIG. 8 illustrates an algorithm is used to calculate the mowing region.

FIG. 9 illustrates nearby stands forming a local group for the calculation of the local border of the mowing region.

FIG. 10 illustrates a stand may extrude out of the lawn ground.

FIG. 11 illustrates the relative distances are calculated.

FIG. 12 illustrates a mowing path of the flexible robotic mower.

FIG. 13 illustrates a mowing path of the flexible robotic mower.

FIG. 14 illustrates a mowing path of the flexible robotic mower.

FIG. 15 illustrates the lawn yard may be mowed with various patterns and geometries and the lawn yard grass may be cut with different depths.

FIG. 16 illustrates the stands are located at the border of the mowing region, inside the mowing region, and outside the mowing region.

FIG. 17 illustrates the stand may be movable from one location to another location, and may be repeatedly used for different locations, and the stand may be flexible to extrude out or squeeze in.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

The invention generally relates to a flexible robotic mower system which allows users to freely use it for different lawns and at different regions in the lawn. The system will firstly determine the mowing region, such as its size and the yard border enclosing the lawn regions. Secondly, after the determination of the border of the lawn, the robotic mower will be ready to start mowing the lawn, a tracking method is used to track the position of the mower inside the mowing region at any time during its operation. Thirdly, after knowing the lawn size and the border of the yard lawn, and the mower's position is tracked at any time during its operation, a microcontroller or a CPU may be on the mower to determine the mowing route and patterns based on users' inputs. With the invention here, the users can utilize the system for their lawn, their neighbor's lawn, or any other different lawns at different places. Furthermore, the system allows the users to vary their mowing region depending on their needs and preferences, and to vary their mowing patterns.

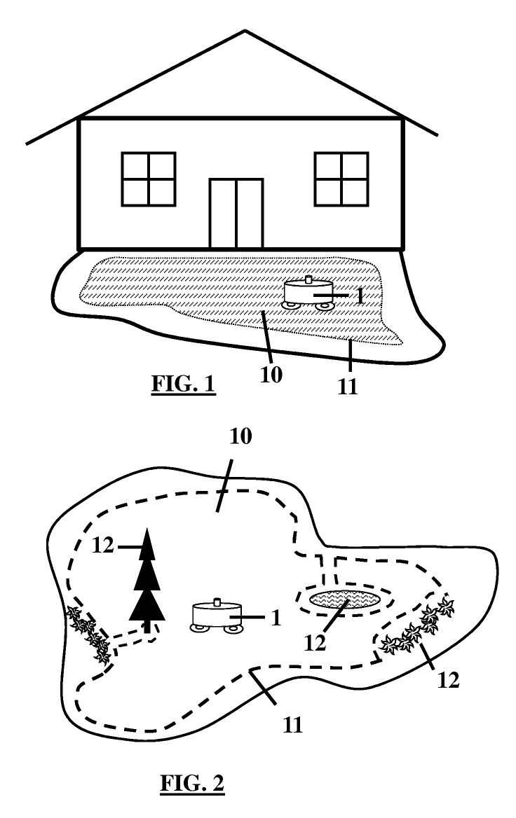

The advantages of the robotic mower are explained in details in the texts and with figures below. FIG. 1 illustrates a typical application of a robotic lawn mower 1. The robotic lawn mower is to mow a lawn region 10 enclosed by its outer boundary 11. An important operation of the mower is not to travel outside of its outer boundary 11. For this regard, the existing robotic mower, in the market right now, will set up a wire beneath the ground at the lawn's outer border, to constrain the movement of the mower from moving outside. When the robotic mower gets close to the wire, an electromagnetic signal sent out from the wire will be detected by the mower and the mower will know it hits the boundary. The drawback of the wire is that a pre-installation of the wire will be required and it will be extremely difficult to use the robotic mower for neighbor's or other people's lawn yards. Furthermore, users may like to vary their mowing regions depending on grass condition or whatever other personal preference. The available lawn mowers in the market right now do not provide this kind of flexibility and therefore the current invention is to address these needs.

FIG. 2 illustrates one example of the robotic lawn mower 1 is to mow a region with several objects inside. The objects could be a bush of flowers, a swimming pool, a tree, and other things. The robotic lawn mower 1 is not allowed to go across or bump into these objects. The dashed line in the figure illustrates a possible way of setting up the wire so the robotic lawn mower will not go across the border and enter into the prohibited regions. In one embodiment, the wire is difficult to install for such a complex geometry, and people may prefer not to dig the lawn yard to install the wiring. In another embodiment, people may not want to mow the entire region in one shot, and may want to separate the entire lawn into several regions, and do the mowing of each region at the time of their convenience. Therefore, a flexible robotic system will be needed for this kind of situation.

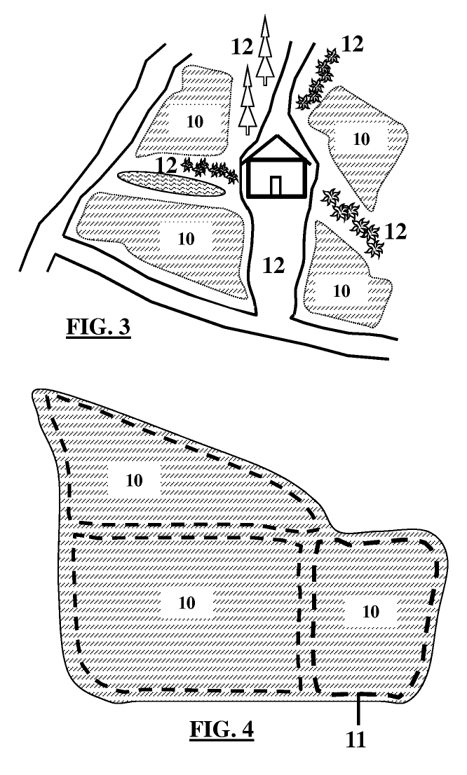

FIG. 3 illustrates a possible situation that the lawn regions 10 to be mowed could be separated from each other and not connected together. The regions may be separated from each other by a bush of flower, a concrete road, a swimming pool, trees, or something else. For the situation, it will be very difficult to set up the wires in each region's border, and a flexible robotic mower will be preferred. Another situation is that people may want to mow different lawns at totally different locations, and the lawn may have various geometries and landscapes, and therefore, it will be not practical to use the wires for such situations. The installation of the electric wires for a gardener who wishes to use robotic lawn mowers for his 100 customers seems if not impossible will be very tedious work.

FIG. 4 illustrates, for some situations, users may want to mow different regions at different time even the regions are connected together. The dash lines shown here illustrate the examples of separated regions. In one embodiment, these regions may be overlapped or separated.

In summary, for above stated possible situations, a flexible robotic lawn mower may be needed. The flexible robotic lawn mower provides the users to freely define their mowing regions, and user can use the system at any places without the need to set up the electrical wires.

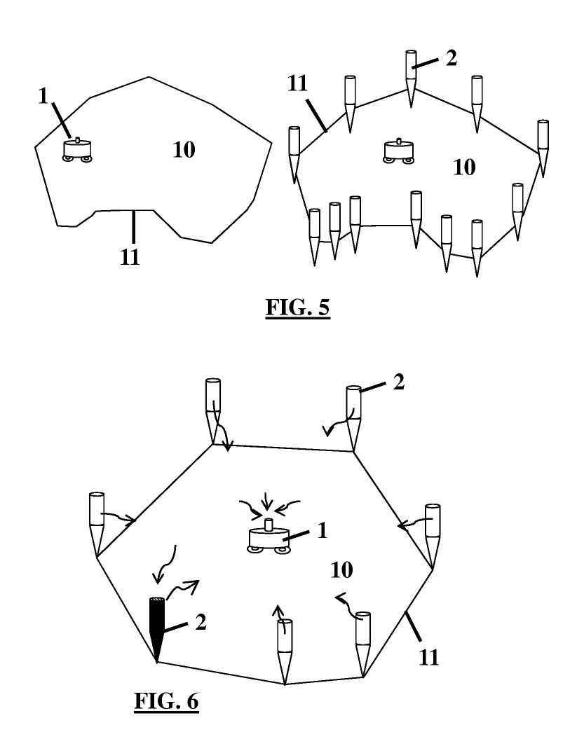

FIG. 5 illustrates the application of the flexible robotic lawn mower system. The system contains one or more robotic mowers 1. The robotic lawn mower 1 is to be put inside a lawn region 10 to be mowed. The region's geometry and size could be different. To define the mowing region 10, the easiest way is to put stands 2 near the outer border or at the peripheral of the lawn region 10. Before the usage of the flexible robotic mower system, the stands 2 may be inserted into the ground along the border of the lawn. In one embodiment, the more number of stands 2 will be better to capture the geometry of the mowing region. However, if the geometry is quite simple, then there is no need to put lots of stands 2. For a square lawn region, four of stands 2 may be enough to depict the mowing area. For a lawn region which has curves or irregular shapes on the border, more stands 2 may be needed for the robotic mower to accurately capture the region.

FIG. 6 illustrates that the stands 2 have ultrasonic transmitter on them and robotic mower may have signal receiver on it. The stands 2 may transmit ultrasonic waves toward the robotic mower 1 and toward other stands 2. The transmitted sound may travel from the stands 2 toward the robotic mower, and by calculating the time to reach mower, the relative distances from stands 2 to mower can be obtained. To accurately calculate the time of traveling, the stands and mower may have an internal electrical timer and the timer may be synchronized. The mower and stands may be synchronized before the use of the system, or being synchronized with the help wireless electronic devices. In real application, the wireless perfect synchronization is difficult to achieve due to the latencies of the electronic devices. However, the timing can be still calibrated when the latencies of the devices are known. In one embodiment, the mower and stands may have RF, or lighting, or infrared devices to synchronize or to calibrate the timings of all parts. The synchronization and calibration of the timings of mower and stands may be done with RF or light devices. One example is that mower to send out a RF signal toward all stands, and by calibration of the latencies of the RF and lighting devices, the timing of each device can be accurately obtained.

FIG. 7 illustrates that the stands 2 may have ultrasonic receivers on them to receive transmitted ultrasonic waves from other stands 2. By calculating the time needed to travel from transmitting stands 2 to receiving stand 2, the relative distances of the stands 2 may be obtained. For the figure shown here, the black stand 2 is assumed to have both ultrasonic transmitter and receiver on it, while the white stand 2 is assumed to have only ultrasonic transmitter on it.

In one embodiment, the robotic lawn mower may have other detectors on it, such as an infrared. The robotic lawn mower may use it to detect any objects inside the mowing region. The infrared light may be used to avoid the mower to collide with objects.

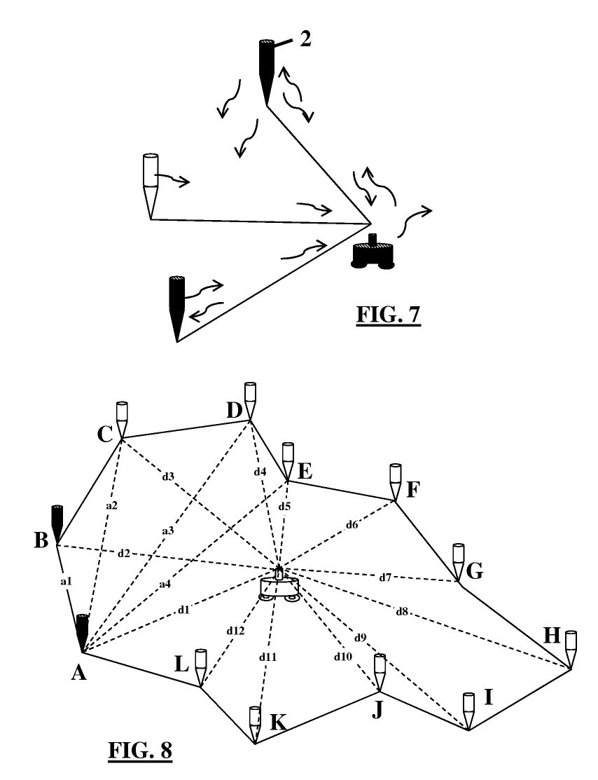

FIG. 8 illustrates one possible way to calculate the geometry of the mowing area based on the stands 2 which are put at the border of the mowing region. The stands 2 here are assumed to have ultrasonic transmitter on them. In the beginning of the operation, the robotic mower is put inside the mowing region to receive the ultrasonic waves from the stands 2. By calculating the needed time for sound to travel from one stand 2 to robotic mower, the distance between the two devices can be calculated. In the figure, the d1 on the dash line is the distance between stand A and robotic mower, the d2 on the dash line is the distance between stand B and robotic mower, the d3 on the dash line is the distance between stand C and robotic mower. Following the same procedure, all the distances from stands to robotic mower, can be calculated. In one embodiment, different stands may transmit ultrasonic waves toward mower at different time and the ultrasonic waves may have different frequencies so they won't interfere with each other.

In one embodiment, stands 2 may be equipped with ultrasonic receivers on them as well. For the example shown in the figure, the stand A and B are equipped with ultrasonic receivers. The transmitted ultrasonic signals from other stands 2 may be received by stands A and B. Therefore, again, the distances from other stands 2 to the stands of A and B can be calculated based on the needed travel times of ultrasonic waves. In the figure, the a1 on the solid line is the distance between stands B and A, the a2 on the dash line is the distance between stands C and A, the a3 on the dash line is the distance between stands D and A, and so on. For the example, only stands A and B are equipped with ultrasonic receivers. In one embodiment, one or more stands 2 may have ultrasonic receivers on them. If the purpose is to calculate the relative distances between other stands 2 to stand A, then only the stand A will need to have signal receiver on it.

By doing a series of calculation, the relative distances of all the stands 2 to the robotic lawn mower can be obtained, and all the relative distances of other stands 2 to stand A are obtained as well. Based on these relative distances, the mowing area or region can be constructed. For the example shown here in FIG. 8, we may choose the initial location of robotic lawn mower as the origin of the coordinate, and with the known of all relative positions of all the stands 2 from A to L, a region of mowing area may be depicted. The constructed region here will be a freeform multi-vertices connected by straight solid line. In one embodiment, the choice of reference position or the location of origin can be arbitrarily picked to construct the mowing region. The origin can be at stand A, at stand B, at initial location of robotic mower, or at any locations. The motion of the robotic mower hereafter shall be within the straight lines which are enclosing the entire mowing region.

In one embodiment, the mowing region may be constructed by connecting the vertices into straight lines as shown in FIG. 8. The motion of the robotic mower will be enclosed by these straight lines. In another embodiment, the curves or splines passing through the vertices may be used to construct the border of the mowing region.

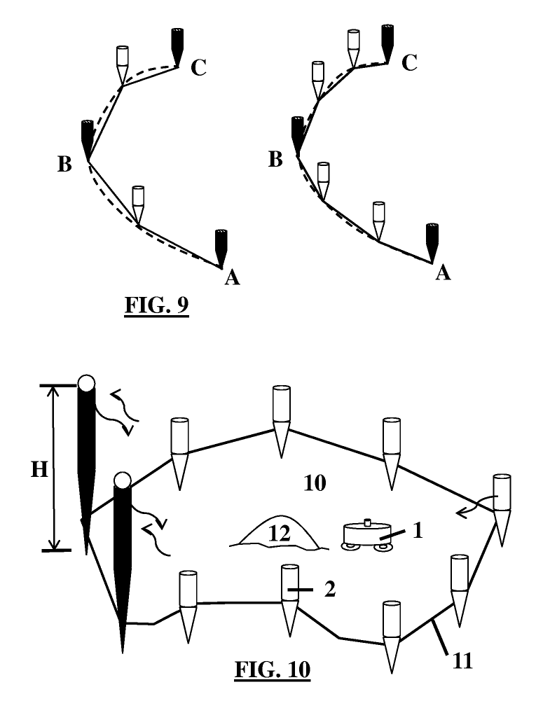

In FIG. 9, the connecting lines between stands 2 can be straight lines or curved lines. The curve may be obtained by the curve fitting using various mathematic algorithms. In one embodiment, the number of vertices or locations of stands 2 used for the curve fitting may be arbitrarily adjusted. The left figure of FIG. 9 illustrates less number of points is used to do the curve fitting, while the right figure use more points to do the curve fitting. More points may be more accurate for complex lawn geometry but the simulation time may be longer and the system will consume more CPU or microcontroller resources. In one embodiment, the curve fitting may be based on a few nearby stands and not all the stands 2 enclosing the mowing area. The curve fitting based on a few nearby vertices will be good for saving the computational time and CPU resources. In one embodiment, the entire outer boundary may be divided into several segments to do the curve fittings.

After the definition of the mowing region, the robotic mower may be ready to start doing the mowing, and the tracking of the mower's position at any time during its operation will be needed for the system to work properly and smartly. For this regard, the stands 2 may transmit the ultrasonic waves toward the mower, and the distances between the mower and stands 2 may be calculated based on the traveling time as mentioned earlier. Take FIG. 8 for example, the stands A and B transmit ultrasonic signals toward the mower and the distances of d1 and d2 are calculated. Hence the mower's position at any time, during its mowing operation, is obtained. In one embodiment, the number of stands 2 transmitting ultrasonic waves may be more than two, and the mower's position may be based on a few of the ultrasonic transmitting stands 2. In another embodiment, the stands 2 may be located at appropriate locations for better monitoring of the motion of the mower. The stands 2 may be at the border, inside the lawn yard, or outside the lawn yard.

The stands 2 and robotic lawn mower are in general on a flat grass lawn and therefore the system is operated in a 2D domain. In one embodiment, the stands 2 may extrude out of flat lawn ground, as shown in FIG. 10 for which the stand may have a height of H, and the system is operated in a 3D domain. One advantage is that the ultrasonic wave transmitting stands 2 may be better in sending the waves toward the robotic mower 1, especially when there are blocking objects 12 inside the lawn region.

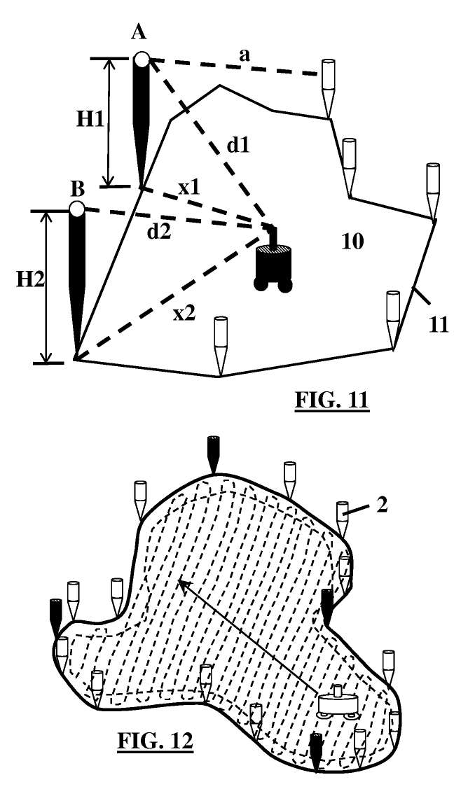

If the stands 2 are extruded out, the configuration of the flexible robotic mower system will be in 3D domain, and the calculation of the relative distances will be different from the case that stands 2 and mower are all on the lawn ground. FIG. 11 illustrates a 3D configuration, the distance from stand A to mower is d1 and the projected distance on ground plane is x1, the distance from stand B to mower is d2 and the projected distance on ground plane is x2. For the situation, the trigonometry will be used to calculate the relative distances, to determine the mowing region, to track the position of the robotic mower during its operation. From the mathematical point of view, the calculation of relative distances for the cases of 2D and 3D are very similar, but in practical application, the 3D configuration may provide the advantage that the ultrasonic waves may be easier to transmit to the receivers. However, a longer simulation time and more consumption of the CPU or microcontroller resources may occur. In another embodiment, a non-flat lawn yard may be analyzed with similar mathematic methodology.

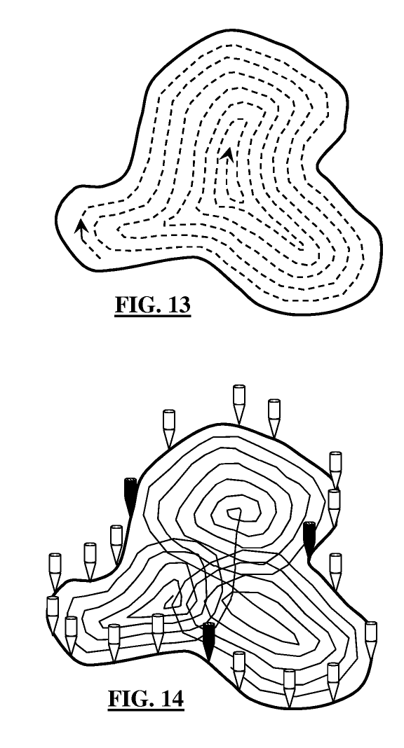

After the mowing region is defined and the position of the robotic mower is being tracked, the next step is to determine the mowing direction, path, and pattern. FIG. 12 illustrates a possible mowing direction which is from one end of mowing area, traveling back and forth, in parallel direction, toward the other end of the mowing area. In one embodiment, at a specific time of operation, the flexible robotic mower may travel along the border of the mowing region, as shown the dash line along the border in the figure, to ensure the peripheral region is mowed. FIG. 13 illustrates another possible rout of lawn mowing which is from outer peripheral toward the center, moving in a spiral or circular pattern. In one embodiment, the route may be from the center toward the outer peripheral.

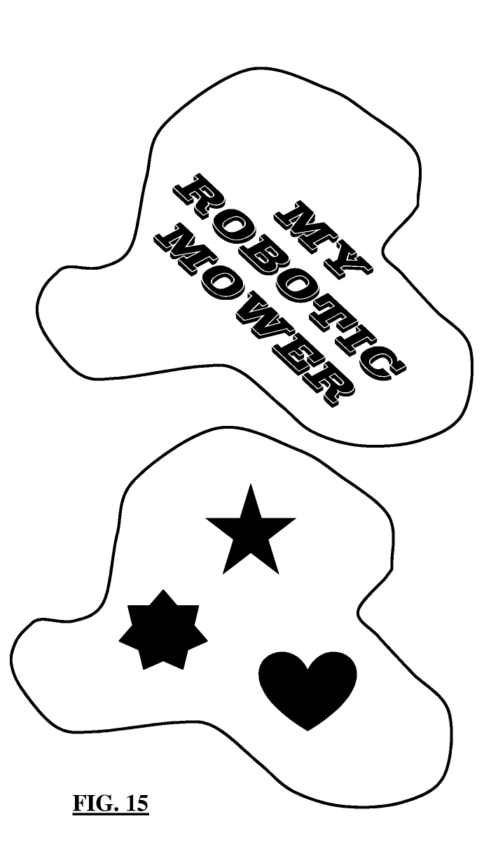

In a further embodiment, various mowing route and path may be implemented and FIG. 14 illustrates another way to mow the lawn area. The mowing route and pattern may be based on the locations of some specific stands 2, for example, only the right and bottom stands 2 are used to define mowing route of the right bottom region. If the bottom and right region is defined as sub-region, then the mower may be able to mow several pre-defined sub-regions one by one depending on the users' preference. In practical application, users may want to mow the lawn several times and to use different routes and paths, and therefore, in one embodiment, the system may use different stands 2 at different locations to create the route for mowing. In conclusion, the pick of mowing region, the pick of stands 2 to define the region, and the mowing route are all flexible and adjustable.

Furthermore, people may like to mow their lawn yards with patterns such as texts, pictures, symbols, and so on, as shown in FIG. 15. The application is similar as the engraving artistic pictures. The engraving is to control that some regions are mowed and some regions are not mowed. In one embodiment, the cutting depth of grass may be programmed as well so the users can design yard's configurations. The creativities of the lawn yard patterns are unlimited, and the flexibilities of yard design may make people's life more pleasant and more diversified.

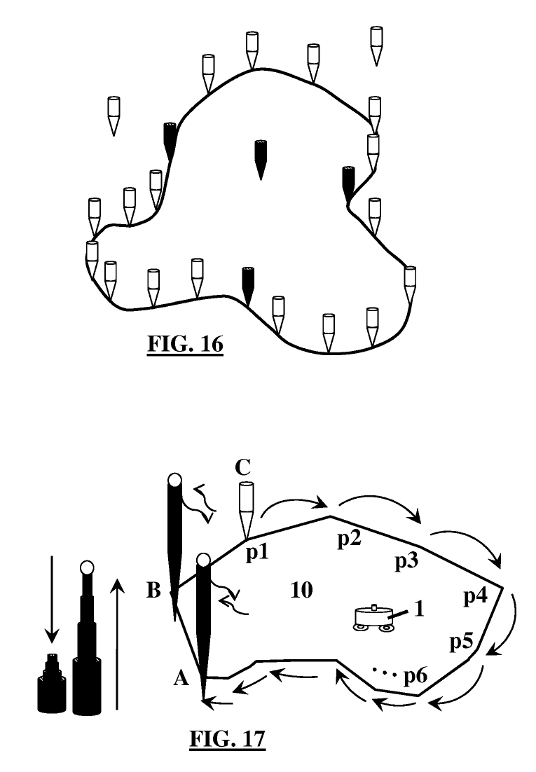

All the stands 2 mentioned so far are located at the border of the mowing region. In one embodiment, the stands 2 may be located inside the yard region, outside the yard region, or exactly at the border of the lawn region, and FIG. 16 illustrates such example. A stand 2 in the middle of the lawn area may help define the sub-regions for mowing and for the tracking of the position of the mower. In one embodiment, the number of stands 2 inside or outside the lawn region may be flexible and adjusted.

The basic operational procedures of the flexible robotic mower system are to (i) define the mowing region and the border of mowing area, (ii) track the position of robotic mower during its operation (iii) mow the lawn region following a programmed route and pattern. The border of the mowing region is defined by several stands 2 as mentioned in the previous text. In one embodiment, very few stands 2 may be needed to do the work and FIG. 17 illustrates the scheme. In the figure, stands A and B are used to track the position of the mower during its operation at any time. The stands A and B may be fixed in the lawn yard if the users do not plan to switch the location for mowing. In another embodiment, the stands 2 may be flexible to extrude out or squeezed in as shown in the figure. When the stands 2 are squeezed in, the system is compact and therefore it will not affect the daily yard activities. In one embodiment, the stands A and B may not need to be on the border of the lawn, and they may locate outside or inside the lawn region. The stand C may be initially located at position p1. It may transmit an ultrasonic wave to stand A and mower, then its position may be obtained by the calculation of the needed time to travel to the receivers, and the information is recorded in the memory device. The next step is to move the stand C to position p2. In a same way of calculation, the position of p2 is obtained and recorded. Following the same procedures, all the positions of the vertices of the mowing region may be obtained and record in the memory device. In one embodiment, the memory device may be located on the mower or on the stand 2.

The advantage of the current flexible robotic mower system is that it is able to define the mowing region, to track the position of the mower at any time during its operation, and to mow the lawn with a defined route and pattern. The mowing route and pattern are to be programmed based on the positions of the stands 2. Unlike other robotic mowers whose mowing routes are basically not controllable and the mowers move randomly, and hence they may consume much more battery power, and take longer time to finish the mowing. The current flexible robotic mower system is to mow the lawn smartly, to save battery life, and to reduce the mowing time.

The ultrasonic signal is mostly referred in the application so far. In one embodiment, other types of signals may be used to measure the relative distances, and other types of transmitted signals may be setup on the stands 2 and on robotic lawn mower 1. In one embodiment, a laser beam, a fiber optic, an infrared light sensor may be used to determine the relative distances. In another embodiment, the temperature and other environmental factors may need to be considered in order to accurately calculate the relative distances.

What is claimed is:

1. A system and apparatus for mowing the lawn yard, comprising a robotic lawn mower base and the ultrasonic sensor nodes built on the stands and mower base, to allow users to define the mowing regions, to track the position of robotic lawn mower base, and to program the mowing routes;

2. The robotic lawn mower of claim 1, wherein the devices of sensor nodes built on the stands are to be flexibly installed by users, at the border of lawn yard, inside the lawn yard, and outside the lawn yard to transmit and to receive the ultrasonic waves, to define the mowing boundary, and to track the position of robotic lawn mower;

3. The robotic lawn mower of claim 1, wherein the devices of stands are operational at flat lawn yard regions and operational at non-flat lawn yard regions, and the stands are to function at 2D domain, and to be extruded out to function at 3D domain, to control and monitor the motion of the robotic lawn mower base;

4. The robotic lawn mower of claim 1, wherein the devices of stands are to be installed at fixed locations and are movable to be relocated to different locations and different lawns, and the stands may be repeatedly used at different locations to define the boundary of the mowing region;

5. The robotic lawn mower of claim 1, wherein the devices of stands are used to determine the mowing routes, the local stands are used to determine the mowing routes at local regions, and all stands may be used to determine the mowing route of the entire region of the lawn yard;

7. The robotic lawn mower of claim 1, wherein the apparatus of stands and robotic lawn mower base are to be synchronized and to be calibrated so the traveling timings of ultrasonic waves are obtained; the synchronization and calibration are to be done with an electronic mean, with RF devices, and with lighting devices.

8. The robotic lawn mower of claim 1, wherein the apparatus of flexible robotic lawn mower is to mow the lawn yard with programmed patterns, with specified routes, and with designed grass cutting depth;

9. The robotic lawn mower of claim 1, wherein the apparatus of robotic lawn mower base and stands may have CPU or microcontroller to do the simulation to determine the mowing routes, and may have a memory device to store the mowing routes and to record the positions of the stands, and to monitor the position of the robotic lawn mower base during the mowing;

10. The robotic lawn mower of claim 1, wherein the devices of ultrasonic sensor nodes on the robotic lawn mower base and stands may be operated with different frequencies and at different time period;

11. The robotic lawn mower of claim 1, wherein the apparatus of stands are to define the mowing regions and to monitor the position of the robotic lawn mower;
